(19) United States
(12) Patent Application Publication
(10) Pub. No.: US 2018/0164733 A1
(43) Pub. Date: Jun. 14, 2018

(54) IMAGE FORMING APPARATUS

(71) Applicant: KONICA MINOLTA, INC., Tokyo (JP)

(72) Inventor: Keisuke MORITA, Tokyo (JP)

(73) Assignee: KONICA MINOLTA, INC., Tokyo (JP)

(21) Appl. No.: 15/825,425

(22) Filed: Nov. 29, 2017

(30) Foreign Application Priority Data
Dec. 14, 2016 (JP) 2016-242703

(51) Int. Cl. G03G 15/00

(52) U.S. Cl. CPC G03G 15/6576; G03G 15/2064

(57) ABSTRACT

An image forming apparatus includes an image forming device that forms an image and a controller that acquires an image reading result of reading of an image of a transfer medium and determines a curling state of the transfer medium. In the determination of the curling state, a prescribed parameter extracted from the image reading result is compared with a prescribed parameter reference, thereby deciding the curling state according to the comparison result.

The entire disclosure of Japanese Patent Application No. 2016-242703 filed on Dec. 14, 2016, is incorporated herein by reference in its entirety.

### BACKGROUND

### Technological Field

The present invention relates to an image forming apparatus that can determine a curling state of a transfer medium.

### Description of the Related Art

Image forming apparatuses such as a copier, a facsimile machine, a printer, and a composite machine having combined functions involve the process of transferring an image to a sheet of paper and fixing the image with heat and a pressure. In this process, the sheet passes through a transfer drum (belt) and a fuser when the image is fixed. At that time, the sheet is likely to be curled. A curled sheet deteriorates printing quality, causes faulty loading, and makes it difficult to perform proper post processing including binding. The cause of curling is not limited. In some cases, sheets fed in preparation for image formation are transported in a curled state.

Thus, a device including a curl corrector provided on a sheet transport path of an image forming apparatus to correct a curled sheet is proposed.

For example, Japanese Patent Laid-Open No. 10-91038 proposes a technique of deciding an application pattern based on a detection result obtained by curl detecting means including a mechanical mechanism.

Japanese Patent Laid-Open No. 2015-219328 proposes a technique of detecting a curl of an intermediate transfer belt, adjusting an image by selecting a toner position adjusting pattern according to a curling state.

Moreover, Japanese Patent Laid-Open No. 2015-214401 proposes a technique of detecting the direction and size of a curl by means of a curl detecting unit including a mechanical mechanism and correcting the curl based on curl information detected by the curl detecting unit.

In the related art, however, a sheet curling state is detected by the mechanical mechanism, disadvantageously leading to a complicated apparatus and high apparatus cost.

### SUMMARY

The present invention has been devised in view of the circumstances. An object of the present invention is to provide an image forming apparatus that can properly determine a curling state of a transfer medium while suppressing an increase in apparatus cost.

To achieve at least one of the abovementioned objects, according to an aspect of the present invention, an image forming apparatus reflecting one aspect of the present invention includes an image forming device that forms an image and a controller that acquires an image reading result of reading of an image of a transfer medium and determines a curling state of the transfer medium based on the image reading result.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram showing the mechanical configuration of an image forming apparatus according to an embodiment of the present invention;

FIG. 2 shows the control block of the image forming apparatus;

FIG. 3 is a perspective view schematically showing an output sheet reader;

FIG. 4 is a schematic diagram showing a decal adjusting unit;

FIG. 5 is a flowchart showing the steps of determining a curling state of a sheet according to the embodiment of the present invention;

FIG. 6 is a flowchart showing the steps of determining a curling state of a sheet according to another embodiment of the present invention;

FIG. 7 is a flowchart showing the steps of determining a curling state of a sheet according to still another embodiment of the present invention;

FIG. 8 is an explanatory drawing showing a comparison between a sheet size serving as a prescribed parameter and a feeding sheet size serving as a prescribed parameter reference;

FIG. 9 is a flowchart showing the steps of determining a curling state of a sheet according to still another embodiment of the present invention;

FIG. 10 shows a reference output image having detection images and read images;

FIG. 11 is a flowchart showing the steps of determining a curling state of a sheet according to still another embodiment of the present invention;

FIG. 12 is a flowchart showing the steps of determining a curling state of a sheet according to still another embodiment of the present invention; and

FIG. 13 is a flowchart showing the steps of determining a curling state of a sheet and correcting a curl according to still another embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

Embodiments of the present invention will be described below with reference to the accompanying drawings.

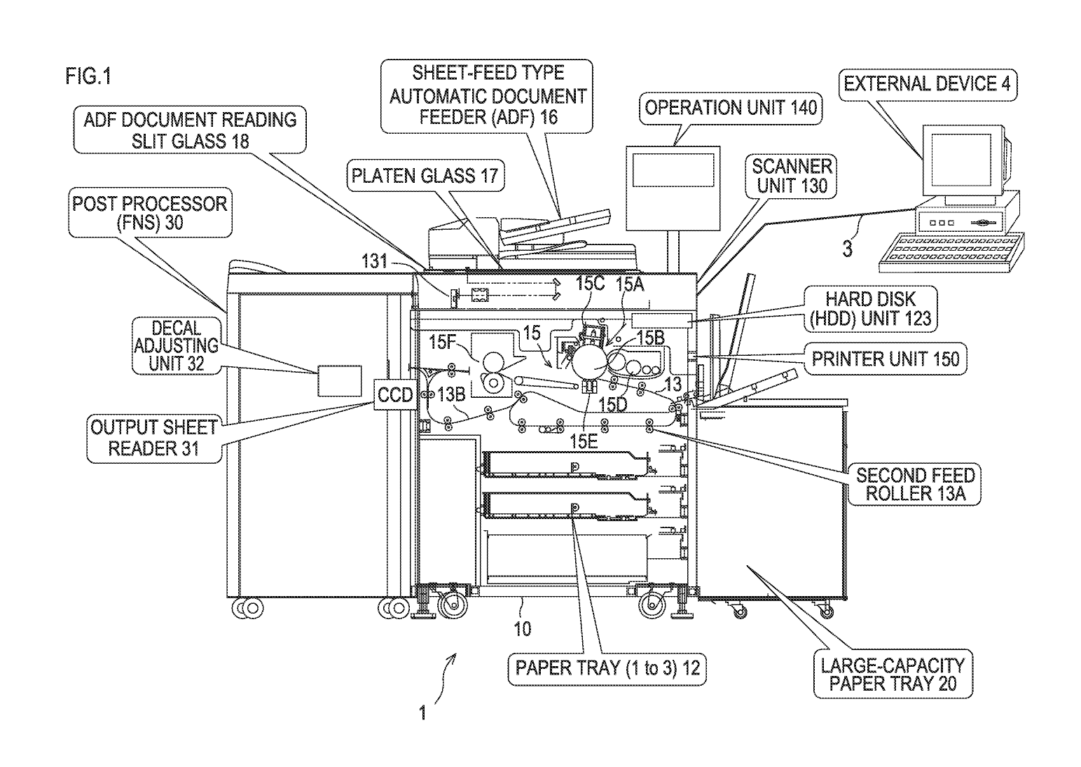

FIG. 1 is a central cross-sectional view showing the mechanical configuration of the overall image forming apparatus. The configuration will be discussed below.

An image forming apparatus 1 includes an image-forming-apparatus body 10. A large-capacity paper tray 20 is connected to the front of the image-forming-apparatus body 10 and a post processor (FNS) 30 is connected to the rear of the image-forming-apparatus body 10. In the image forming apparatus 1, sheets can be transported between the devices, and the devices can communicate with one another. The post processor can be included in the image-forming-apparatus body 10.

In the image-forming-apparatus body 10, a scanner unit 130 including a CCD 131 and a sheet-feed type automatic document feeder (ADF) 16 are provided in the upper part of a cabinet. A document image can be read through a platen glass 17 or a slit glass 18 for ADF document reading.

An document reading unit includes the scanner unit 130, the sheet-feed type automatic document feeder (ADF) 16, the platen glass 17, and the slit glass 18 for ADF document reading.

On the top of the cabinet of the image-forming-apparatus body 10, an operation unit 140 having a touch panel LCD is provided in a location where the platen glass 17 is absent, allowing an operation of an operator and display of information. The operation unit 140 constituting an operation unit acts as a display unit. According to the present invention, the operation unit and the display unit can be separated from each other.

A plurality of paper trays (1 to 3) 12 (three in FIG. 1) are disposed in the lower part of the cabinet of the image-forming-apparatus body 10. Moreover, the large-capacity paper tray 20 having a paper tray is disposed next to the image-forming-apparatus body 10.

The cabinet of the image-forming-apparatus body 10 contains a transport path 13 for transporting sheets fed from one of the paper trays and second feed rollers 13A. An image forming device 15 including an LD 15A, a photosensitive body 15B, an electrifier 15C, a developing device 15D, a transfer part 15E, and a fuser 15F is provided near an intermediate point of the transport path 13.

The large-capacity paper tray 20 has a transport path (not shown) for transporting fed sheets into the image-forming-apparatus body 10. The transport path is connected to the transport path 13. Furthermore, the post processor (FNS) 30 has a transport path for ejecting sheets with printed images through or without post processing.

The transport paths have transport rollers for transporting sheets, a transport motor, and so on.

A printer unit 150 includes the image forming device 15, the paper trays (1 to 3) 12, the large-capacity paper tray 20, the transport path 13, and the second feed rollers 13A.

In the image forming device 15, the electrifier 15C, the developing device 15D, and the transfer part 15E are disposed around the photosensitive body 15B. The electrifier 15C uniformly charges the surface of the photosensitive body 15B before an image is written. The LD 15A emits a semiconductor laser to the photosensitive body 15B having the uniformly charged surface, thereby forming an electrostatic latent image on the photosensitive body 15B. The developing device 15D develops the electrostatic latent image formed on the photosensitive body 15B, with a toner material. The development forms a toner image on the photosensitive body 15B. The transfer part 15E transfers the toner image of the photosensitive body 15B to a sheet transported from one of the paper trays (1 to 3) 12 or the large-capacity paper tray 20 through the transport path 13. The sheet having the transferred toner image is separated from the photosensitive body 15B and is transported to the fuser 15F. The toner material left on the photosensitive body 15B is removed by a cleaning unit (not shown).

The fuser 15F heats the transported sheet so as to fix the toner image transferred to the surface of the sheet. In single-sided printing, the sheet with the fixed image is transported through the transport path 13 to the post processor (FNS) 30 located on one side of the image-forming-apparatus body 10.

In double-sided printing, the sheet with the fixed image is switched back through an inverting transport path 13B, and then the image forming device 15 transfers a predetermined image to the back side of the sheet having circulated through the transport path 13. Subsequently, the sheet is transported to the post processor (FNS) 30 after the images on both sides of the sheet are fixed.

An output sheet reader 31 is provided as a CCD line sensor near the entrance of the transport path of the post processor (FNS) 30. In the present embodiment, the output sheet reader 31 corresponds to an image reader of the present invention.

In the output sheet reader 31, a line sensor is made longer than the width of a sheet and a black background board is provided, so that the output sheet reader 31 can detect a sheet outline.

A decal adjusting unit 32 is disposed near the transport path downstream of the output sheet reader 31 so as to correct a curl of a curled sheet. The decal adjusting unit 32 can correct a curl according to a curl correction value (decal adjustment value) calculated based on the image reading result of the output sheet reader 31. In the present embodiment, the decal adjusting unit 32 corresponds to a curl corrector of the present invention.

Furthermore, the post processor (FNS) 30 includes a predetermined postprocessing unit for stapling, punching, folding, bookbinding, and so on. The predetermined postprocessing can be performed by the postprocessing unit. The postprocessing can include multiple kinds of processing.

The post processor (FNS) 30 further includes a plurality of paper output trays, thereby switching the destinations of ejected sheets.

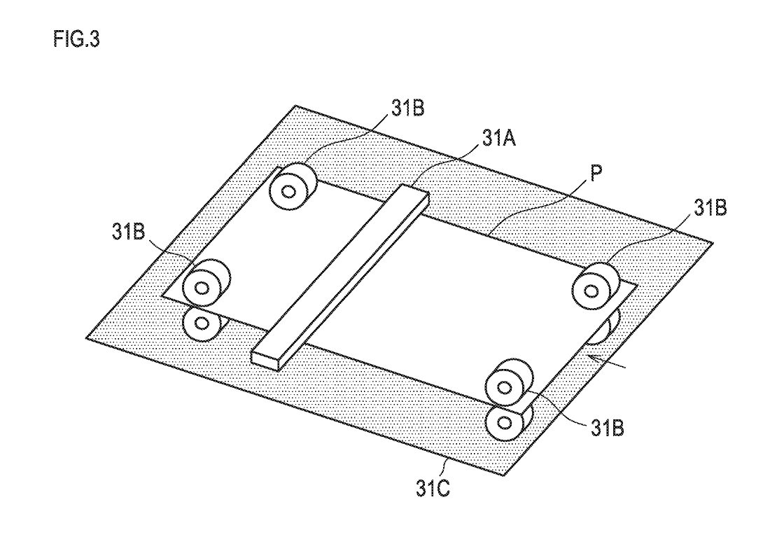

FIG. 3 schematically shows the output sheet reader 31.

In the output sheet reader 31, a CCD 31A for reading an image is provided as a line sensor along the crosswise direction of a sheet P. The CCD 31A is longer than the width of the sheet. Moreover, a black background board 31C is disposed on the opposite side of the sheet P from the CCD 31A so as to sandwich the sheet P from above and below.

Furthermore, nip portions 31B are disposed on both sides of the CCD 31A in a sheet transport direction, thereby capable of switching pressures applied to the sheet. The nip portions in the transport direction and the crosswise direction can be made to separately apply pressures and release pressures. The nip portions 31B can transport the nipped sheet P.

The nip portions can be absent in the image reader of the present invention. The configurations of the nip portions are not limited to the configurations of FIG. 3.

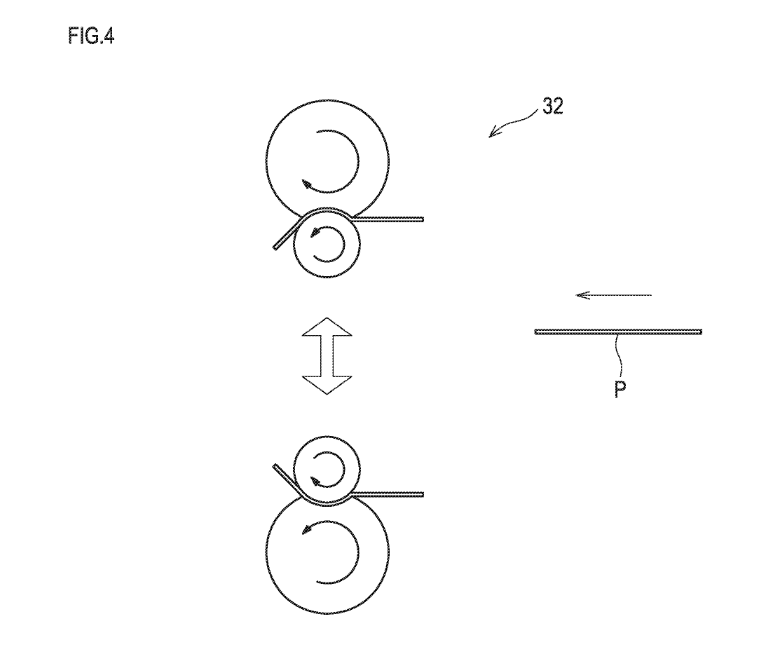

FIG. 4 is a schematic diagram of the decal adjusting unit 32.

The decal adjusting unit 32 can vertically switch units relative to a transported sheet. The units can be switched so as to deal with an upward curling direction and a downward curling direction. For each of the units, a contact position is changed between rollers where the sheet P is inserted, allowing an adjustment of a decal amount. In the present invention, the decal adjusting unit, that is, a curl corrector can have any structure and is not limited to a specific structure.

In the present embodiment, the output sheet reader 31 acting as an image reader is provided in the postprocessing unit. In the present invention, the installation position of the output sheet reader 31 is not particularly limited. The output sheet reader 31 can be installed in the image-forming-apparatus body or a curl detector connected to the image-forming-apparatus body. The output sheet reader 31 can be installed upstream of the image forming device so as to read a sheet before an image is formed. Alternatively, a curl detector can have an image reader outside the image forming apparatus instead of inside the image forming apparatus. If the image reader is installed outside the image forming apparatus, the image reader and the image forming apparatus can be electrically connected to each other via a network or the like. Alternatively, the read data of the image reader can be stored in a movable storage medium that is attached to the image forming apparatus to acquire reading results.

If provided as a curl detector, the curl detector can include an image reader and a detection controller that acquires the image reading results of the image reader and determines a curling state of the transfer medium. The detection controller can include a CPU and programs operating on the CPU. Hardware in the detection controller corresponds to a computer that executes programs. The programs include the program of the present invention.

The detection controller can inform the image formation controller of the image forming apparatus of a detected curling state. In this case, the controller provided in the image forming apparatus so as to control image formation corresponds to an image formation controller.

In the present embodiment, the decal adjusting unit 32 acting as a curl corrector is provided in the postprocessing unit. In the present invention, the installation position of the decal adjusting unit 32 is not particularly limited. The decal adjusting unit 32 can be installed in the image-forming-apparatus body or a correction device connected to the image-forming-apparatus body. The decal adjusting unit 32 to be installed in the image forming apparatus can be disposed upstream of the image forming device so as to correct a curl of a sheet before an image is formed. Alternatively, a curl corrector can be provided outside the image forming apparatus instead of inside the image forming apparatus. If the curl corrector is installed outside the image forming apparatus, a curl can be corrected in response to a curl adjustment value through a network or the like. Alternatively, a curl correction value can be stored in a movable storage medium that is attached to, for example, a curl correcting device to acquire the curl correction value.

The image forming apparatus 1 includes the image-forming-apparatus body 10, the large-capacity paper tray 20, and the post processor (FNS) 30. In the present invention, the number and kinds of devices constituting the image forming apparatus are not particularly limited and multiple post processors can be provided. Additionally, kinds of post processors such as a relay device and a stacking device can be connected to the image forming apparatus. Moreover, the post processor can be provided in the image-forming-apparatus body or can be absent in the image forming apparatus.

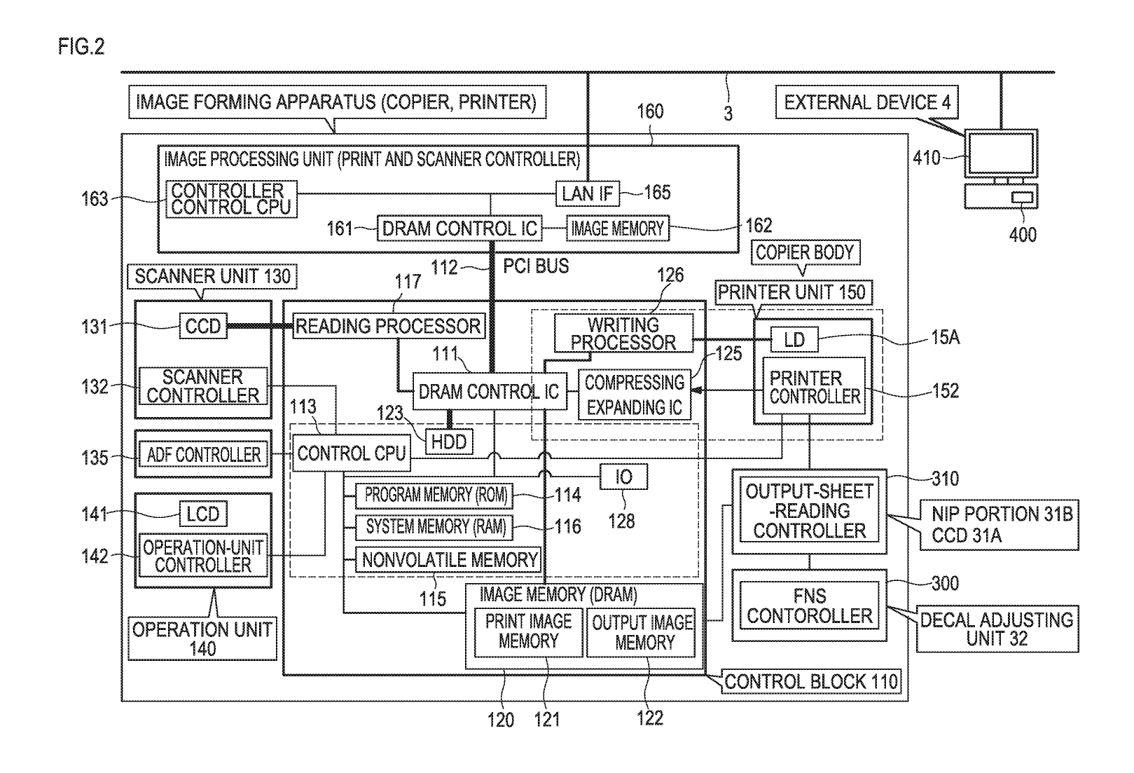

Referring to a block diagram in FIG. 2, the functional configuration of the image forming apparatus 1 will be described below.

The image-forming-apparatus body 10 includes a control block 110, the scanner unit 130, the operation unit 140, and the printer unit 150. The image-forming-apparatus body 10 further includes an image processing unit (print and scanner controller) 160 that can process image data inputted from an external device 4, e.g., a terminal PC through a LAN 3 or transfer image data, which is obtained by the scanner unit 130, to the external device 4 through the LAN 3.

The control block 110 has a PCI bus 112 connected to the image processing unit (print and scanner controller) 160. A DRAM control IC 111 is connected to the PCI bus 112. An image memory (DRAM) 120 is connected to the DRAM control IC 111. The image memory (DRAM) 120 includes a print image memory 121 for storing compressed image data and an output image memory 122 for temporarily storing uncompressed image data to be printed before an image is formed.

A hard disk (HDD) unit 123 is connected to the PCI bus 112. The hard disk (HDD) unit 123 can store such as image data acquired by the scanner unit 130 and image data generated by, for example, the external device 4 connected to the image processing unit (print and scanner controller) 160.

Image data acquired by the image processing unit (print and scanner controller) 160 and image data stored in the hard disk (HDD) unit 123 are transmitted to the DRAM control IC 111 through the PCI bus 112 in response to a printing operation.

The control block 110 includes a control CPU 113. The DRAM control IC 111 is connected to the control CPU 113.

The control CPU 113 is connected to a program memory (ROM) 114 that is constituted of a ROM and stores, for example, programs for operating the control CPU 113, a system memory (RAM) 116 that is constituted of a RAM and is used as a work area, and a nonvolatile memory 115 constituted of a flash memory.

The nonvolatile memory 115 stores initial setting information on the image-forming-apparatus body 10, paper type attribute data, machine setting information including process control parameters and the like, postprocessing settings, paper destination settings, a curl detection/determination method, the extracted contents of prescribed parameters, and a prescribed parameter refference.

The control CPU 113 can read the nonvolatile data of the nonvolatile memory 115 and write desired data in the nonvolatile memory 115.

The control CPU 113 performs a predetermined operation according to the program stored in the program memory (ROM) 114.

The control CPU 113 constitutes the controller of the present invention along with the program memory (ROM) 114, the system memory (RAM) 116, and the nonvolatile memory 115. The control CPU 113 controls the operations of the units of the image forming apparatus 1 according to the machine setting information, printing setting information, and output settings. Moreover, the control CPU 113 acquires the reading results of the output sheet reader 31 and determines a sheet curling state according to a predetermined determination method.

During and after the determination of a curling state, the following processing can be performed:
[*1]: Detect a change of a sheet size in a read image
[*2]: Detect an image deformation from a read image
[*3]: Stop an operation when a change/deformation is detected in [*1] or [*2]
[*4]: Send a warning message when a change/deformation is detected in [*2] or [*3]
[*5]: Decide a decal adjustment value according to an amount of change/direction of deformation+−/amount of deformation detected in [*2] or [*3]

Furthermore, through the operation unit 140, the control CPU 113 can provide an instruction of job output settings, operation instructions, ON/OFF settings for determining a curling state, and instructions of stopping an output operation when the presence of a curl is determined. The operation unit 140 can provide kinds of display, e.g., a warning message when the presence of a curl is determined.

The scanner unit 130 includes a CCD 131 for optical reading and a scanner controller 132 that controls the overall scanner unit 130. The scanner controller 132 is connected to the control CPU 113 so as to serially communicate with each other. The CCD 131 is connected to a reading processor 117 that processes image data read by the CCD 131. The reading processor 117 is connected to the DRAM control IC 111 so as to be controlled by the DRAM control IC 111.

The reading processor 117 performs kinds of processing such as analog signal processing, analog-to-digital (A/D) conversion, and shading on an analog image signal inputted from the CCD 131, generating digital image data. The digital image data is then outputted to a compressing expanding IC 125 through the DRAM control IC 111.

An ADF controller 135 is connected to the control CPU 113 in a controllable manner. The sheet-feed type automatic document feeder (ADF) 16 is controlled by the ADF controller 135.

In the scanner unit 130, image data is obtained by reading an image of a document placed on the top platen glass of the image-forming-apparatus body 10 and a document automatically transported by the sheet-feed type automatic document feeder (ADF) 16.

The operation unit 140 includes an LCD 141 that acts as a display part and an operation part with a touch panel, and an operation-unit controller 142 that controls the overall operation unit. The operation-unit controller 142 is connected to the control CPU 113 so as to serially communicate with each other.

In the operation unit 140, the LCD 141 under the control of the control CPU 113 allows a mechanical setting input, e.g., output condition settings or operation control conditions in the image-forming-apparatus body 10, a setting input of paper information (a size, a paper type) on paper trays, the display of setting contents, and the display of desired information including messages.

The compressing expanding IC 125 is connected to the DRAM control IC 111 so as to compress or expand image data. In response to an instruction from the control CPU 113, the DRAM control IC 111 controls image data compression and compressed-image data expansion by the compressing expanding IC 125, and the DRAM control IC 111 controls the input and output of image data to and from the image memory (DRAM) 120.

A writing processor 126 is connected to the image forming device 15 including the LD 15A of the printer unit 150, and the writing processor 126 generates written data used for the operation of the LD 15A based on image data.

The printer unit 150 includes the image forming device 15, the paper trays (1 to 3) 12, the transport path 13 (including the inverting transport path 13B), and the fuser 15F.

The printer unit 150 includes a printer controller 152 that controls the overall printer unit 150 (including paper feeding, image formation, paper ejection, and postprocessing). The printer controller 152 is connected to the control CPU 113 so as to serially communicate with each other. The printer controller 152 operates in response to a control command of the control CPU 113. The printer controller 152 controls the printer unit 150 so as to transport a sheet or form an image. The printer controller 152 can instruct the compressing expanding IC 125 to expand compressed image data.

Moreover, an output-sheet-reading controller 310 and an FNS controller 300 in the post processor (FNS) 30 are connected to the printer controller 152.

The nip portions 31B and the CCD 31A are connected to the output-sheet-reading controller 310 in a controllable manner.

The decal adjusting unit 32 is connected to the FNS controller 300 in a controllable manner.

The printer controller 152 can instruct the output-sheet-reading controller 310 and the FNS controller 300 in response to a command of the control CPU 113. In the output-sheet-reading controller 310, the reading results of the output sheet reader 31 are stored in the image memory (DRAM) 120 in a readable manner.

A DRAM control IC 161 of an image processing unit (print and scanner controller) 160 is connected to the PCI bus 112 that is connected to the DRAM control IC 111. When the image-forming-apparatus body 10 is used as a network printer or a network scanner, the image processing unit (print and scanner controller) 160 in the image-forming-apparatus body 10 receives image data and so on from, for example, the external device 4 connected to the LAN 3, or the image processing unit (print and scanner controller) 160 transmits image data acquired by the scanner unit 130 to the external device 4, e.g., a terminal PC connected to the LAN 3.

In the image processing unit (print and scanner controller) 160, an image memory 162 including a DRAM is connected to the DRAM control IC 161. In the image processing unit (print and scanner controller) 160, a common bus is connected to the DRAM control IC 161, a controller control CPU 163 that controls the overall image processing unit (print and scanner controller) 160, and a LAN interface 165. The LAN interface 165 is connected to the LAN 3.

Furthermore, an IO unit 128 is connected to the control CPU 113. The IO unit 128 acts as an interface that transmits and receives information between the units and the control CPU 113 in the image forming apparatus 1.

For example, the control CPU 113 can communicate with a sensor disposed on the path of the image forming apparatus 1 so as to detect a sheet, through the IO unit 128.

The external device 4 includes an external device controller 400 and an external device operation unit 410. The external device controller 400 controls the overall external device 4. The external device controller 400 includes a CPU, programs operating on the CPU, and a storage unit that stores operation parameters. The external device operation unit 410 can be separately provided with an operation part and a display part.

The external device 4 can be used as an information processor that determines a curling state of a transfer medium in response to the reading result of the image reader. If the external device 4 is used as an information processor, the external device controller 400 corresponds to an information processing controller of the present invention. In this case, a program executed by the hardware of the external device controller 400 corresponds to a program of the present invention.

The program of the present invention can be distributed and moved while being stored in, for example, a portable storage unit or can be stored in the storage unit of the external device controller 400 through a network or the like. The external device 4 can also manage the image forming apparatus and control image formation. In this case, the information processing controller acts as an image formation controller.

### First Embodiment

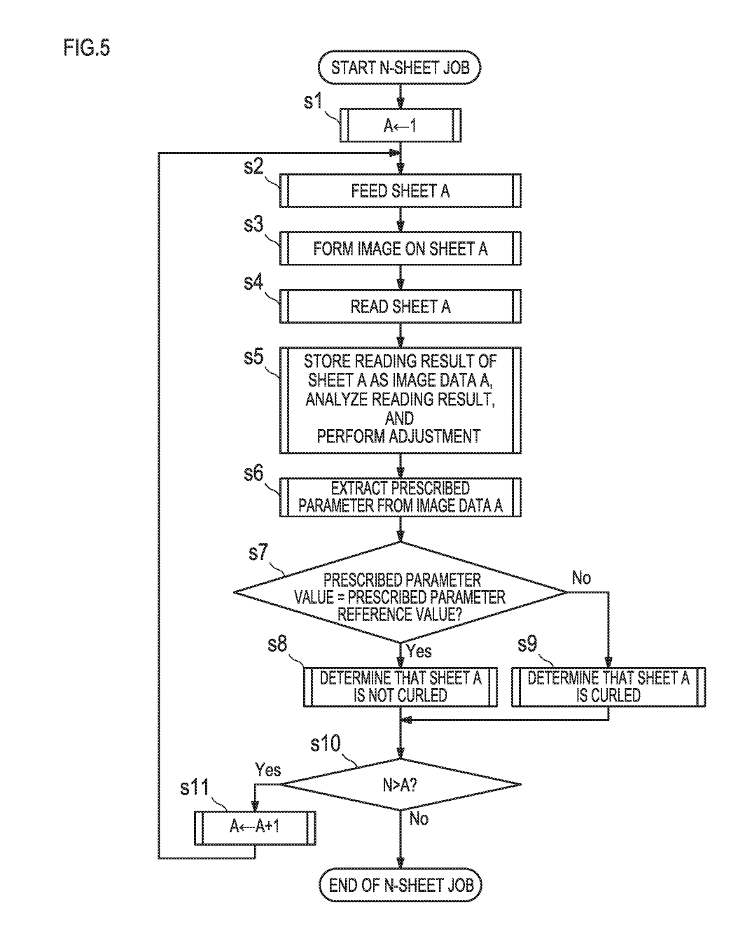

Referring to the flowchart of FIG. 5, the steps of detecting a curling state of a transfer medium will be discussed below. The steps are performed under the control of a controller, an information processing controller, or a detection controller (the same hereinafter).

First, 1 is substituted in a variable A (step s1). Subsequently, a sheet A is fed (step s2) and then an image is formed on the sheet A (step s3).

The sheet A is then read by the output sheet reader (step s4), the reading result of the sheet A is stored as image data A, the reading result is analyzed, and the image quality of the image forming device is adjusted (step s5).

Subsequently, a prescribed parameter is extracted from the image data A (step s6). Contents to be extracted are set beforehand for the prescribed parameter. For example, the contents include an output sheet size, a curl detection image, and the outline of an image edge. The extracted contents are stored in the nonvolatile memory 115 and the HDD 123. The extracted contents can be selected by a user operation of the operation unit.

After that, a prescribed parameter value and a prescribed parameter reference value are compared with each other (step s7). The prescribed parameter reference value depends on the contents of the prescribed parameter. For example, when the prescribed parameter is an output sheet size, the prescribed parameter reference value is a feeding sheet size. When the prescribed parameter is a curl detection image, the prescribed parameter reference value is a curl detection correct image. When the prescribed parameter is the outline of an image edge, the prescribed parameter reference value is the outline of a clear image edge.

If the prescribed parameter value and the prescribed parameter reference value are equal to each other (step s7, Yes), it is determined that the sheet A is not curled (step s8) and then it is determined whether N is larger than A (step s10). N is the number of sheets to be printed in a job (the same hereinafter). If N is larger than A (step s10, Yes), the number of printed sheets does not reach N, the number of sheets to be printed in a job. Thus, 1 is added to A (step s11) and then the process returns to step s2 to feed a sheet A. These steps are repeated.

If the prescribed parameter value is not equal to the specified reference value (step s7, No), it is determined that the sheet A is curled (step s9) and then it is determined whether N is larger than A (step s10). If N is not larger than A (step s10, No), that is, if the number of printed sheets reaches the number of sheets to be printed in a job, the job of N sheets is completed.

In the present embodiment, a curling state can be determined by using the output sheet reader for adjusting image quality. In the image forming apparatus that reads an image to adjust image quality, a curling state can be determined without an additional configuration.

### Second Embodiment

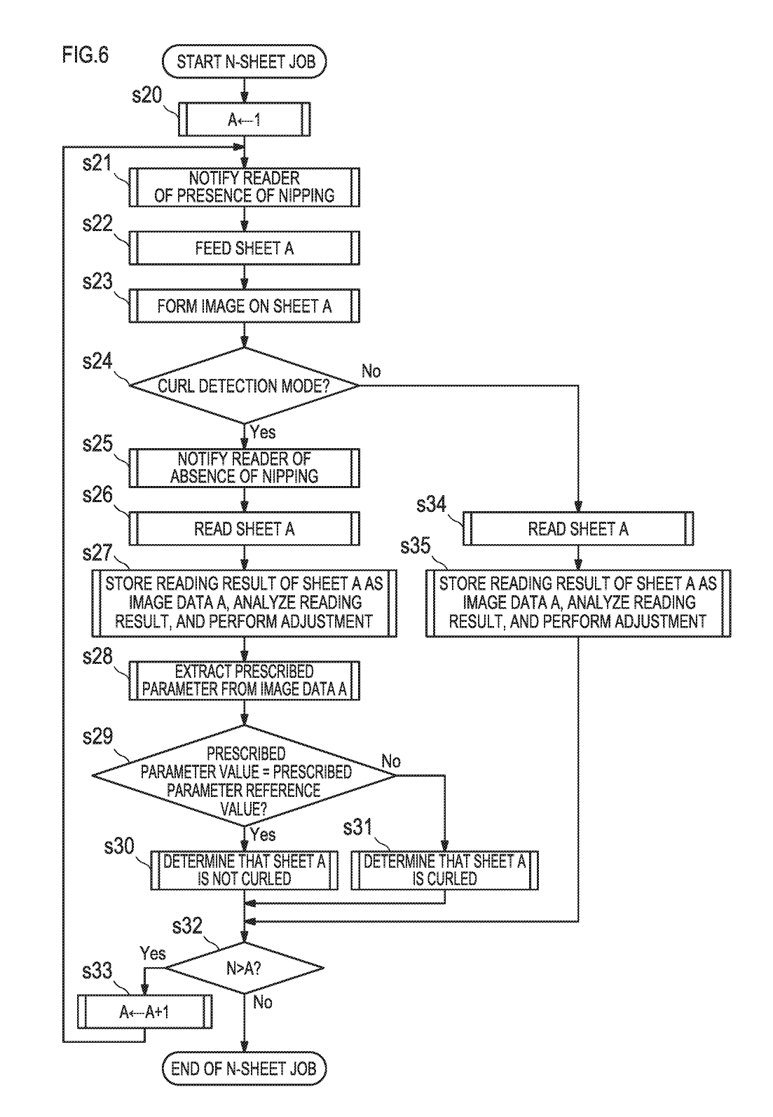

Referring to the flowchart of FIG. 6, the steps of switching of a nipping operation during image reading will be discussed below.

First, 1 is substituted in a variable A (step s20). Subsequently, an output sheet reader is notified of the presence of nipping (step s21), a sheet A is fed (step s22), and then an image is formed on the sheet A (step s23).

After that, it is determined whether the current mode is a curl detection mode or not (step s24). During image formation in an image forming apparatus, switching is enabled between a setting for detecting a sheet curl and a setting where a curl is not detected. One of the settings can be selected according to an initial setting or a user setting can be made at a proper time.

If the current mode is not a curl detection mode (step s24, No), the sheet A is read by a reader (step s34). At this point, the sheet is nipped by a nip portion so as to read an image. The reading result of the sheet A is stored as image data A, and the reading result is analyzed to adjust the image quality of an image forming device (step s35). Subsequently, it is determined whether N is larger than A (step s32). When an image is read to adjust image quality, whether to perform a nipping operation can be set beforehand.

In the case of the curl detection mode (step s24, Yes), the reader is notified of the absence of nipping (step s25). This is because a nipping operation during reading can change a curling state of a curled sheet so as to incorrectly detect a curling state. If image quality adjustment is performed at the same time, image quality can be adjusted, though precision slightly decreases. The reader reads an image on a sheet without a nipping operation (step s26).

Subsequently, the reading result of the sheet A is stored as image data A, the reading result is analyzed, and then the image quality of the image forming device is adjusted (step s27). Image quality adjustment can be performed at another opportunity rather than during the curl detection mode.

After that, a prescribed parameter is extracted from image data A (step s28). The prescribed parameter is similar to that of the foregoing embodiment.

Subsequently, the prescribed parameter value and the prescribed parameter reference value are compared with each other (step s29).

If the prescribed parameter value and the prescribed parameter reference value are equal to each other (step s29, Yes), it is determined that the sheet A is not curled (step s30) and then it is determined whether N is larger than A (step s32). If N is larger than A (step s32, Yes), the number of printed sheets does not reach the number of sheets to be printed in a job. Thus, 1 is added to A (step s33) and then the process returns to step s21 to perform the step of feeding a sheet A.

If the prescribed parameter value is not equal to the prescribed parameter reference value (step s29, No), it is determined that the sheet A is curled (step s31) and then it is determined whether N is larger than A (step s32). If N is not larger than A (step s32, No), the job of N sheets is completed.

In the present embodiment, the curl detection mode is provided. Since an image is read without a nipping operation in this mode, a state of an outputted sheet can be precisely determined.

### Third Embodiment

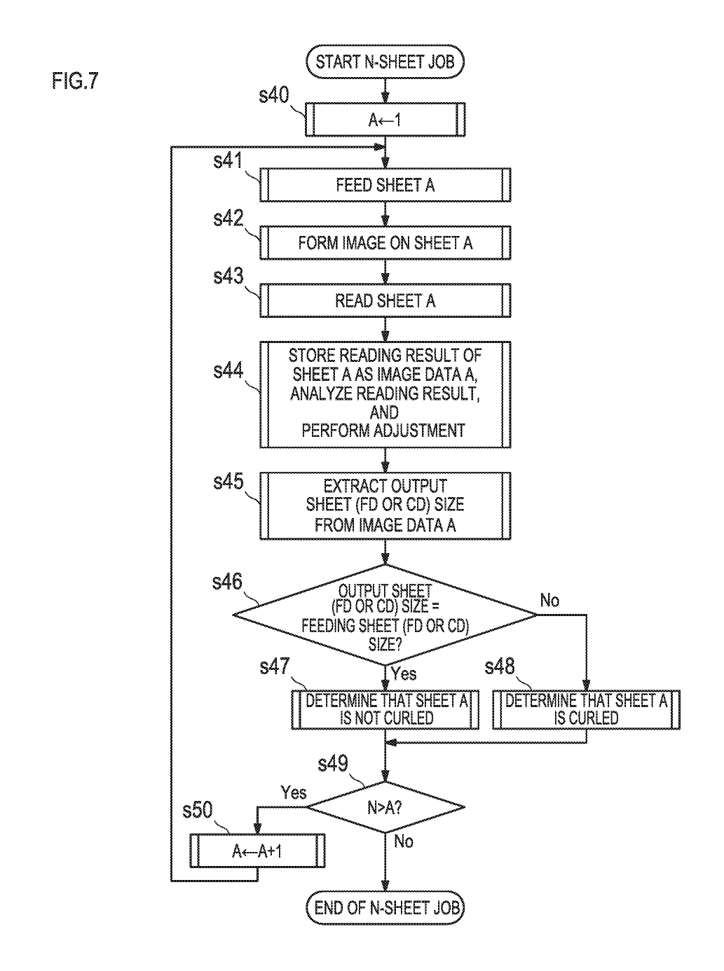

Referring to the flowchart of FIG. 7, the steps of determining a curling state according to a sheet size will be discussed below. The sheet size serves as a prescribed parameter.

First, 1 is substituted in a variable A (step s40). Subsequently, a sheet A is fed (step s41), and then an image is formed on the sheet A (step s42).

The sheet A is read by an output sheet reader (step s43). The reading result of the sheet A is stored as image data A. The reading result is analyzed to adjust the image quality of an image forming device (step s44).

Subsequently, a sheet size in a transport direction (FD) or a sheet size in a crosswise direction (CD) is extracted as a prescribed parameter from image data A (step s45). Alternatively, both of the sizes with FD and CD can be used. Using both of the sizes can improve precision.

After that, an output sheet size serving as a prescribed parameter value and a feeding sheet size serving as a prescribed parameter reference value are compared with each other (step s46).

If the prescribed parameter value and the prescribed parameter reference value are equal to each other (step s46, Yes), it is determined that the sheet A is not curled (step s47) and then it is determined whether N is larger than A (step s49). If N is larger than A (step s49, Yes), 1 is added to A (step s50) and then the process returns to step s41 to perform the step of feeding the sheet A.

If the prescribed parameter value is not equal to the prescribed parameter reference value (step s46, No), it is determined that the sheet A is curled (step s48) and then it is determined whether N is larger than A (step s49). If N is not larger than A (step s49, No), the job of N sheets is completed.

In other words, in the present embodiment, a curl is determined according to a difference in sheet size (FD>FD1, CD<CD1).

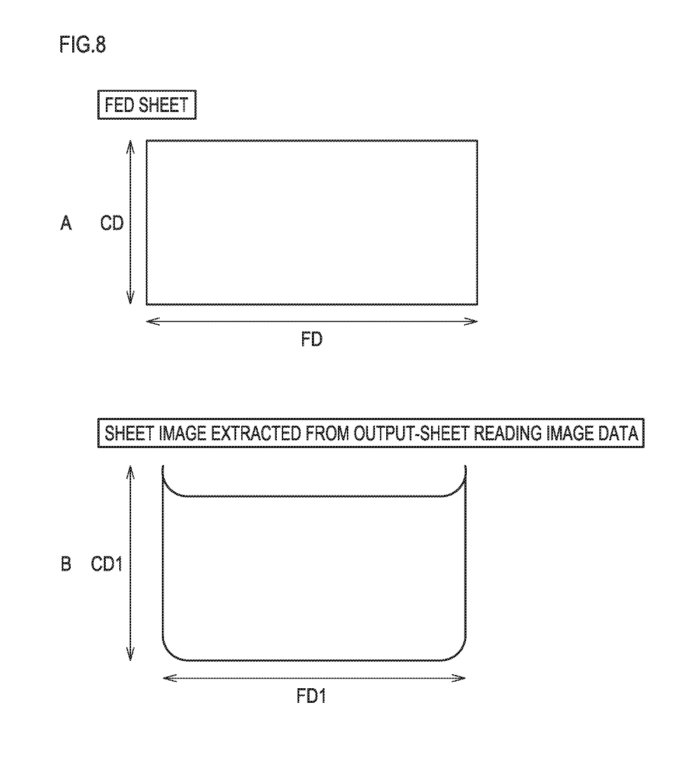

FIG. 8 shows a sheet (A view) having a feeding sheet size as a prescribed parameter reference value and a sheet image (B view) obtained by reading a curled sheet.

The sheet of the feeding sheet size has a size FD in the transport direction and a size CD in the crosswise direction. As a result of analysis, the curled sheet has a size CD1 in the crosswise direction and a size FD1 in the transport direction. Thus, the size of the curled sheet is different from the feeding sheet size. The comparison between the sizes proves that the sheet is curled.

### Fourth Embodiment

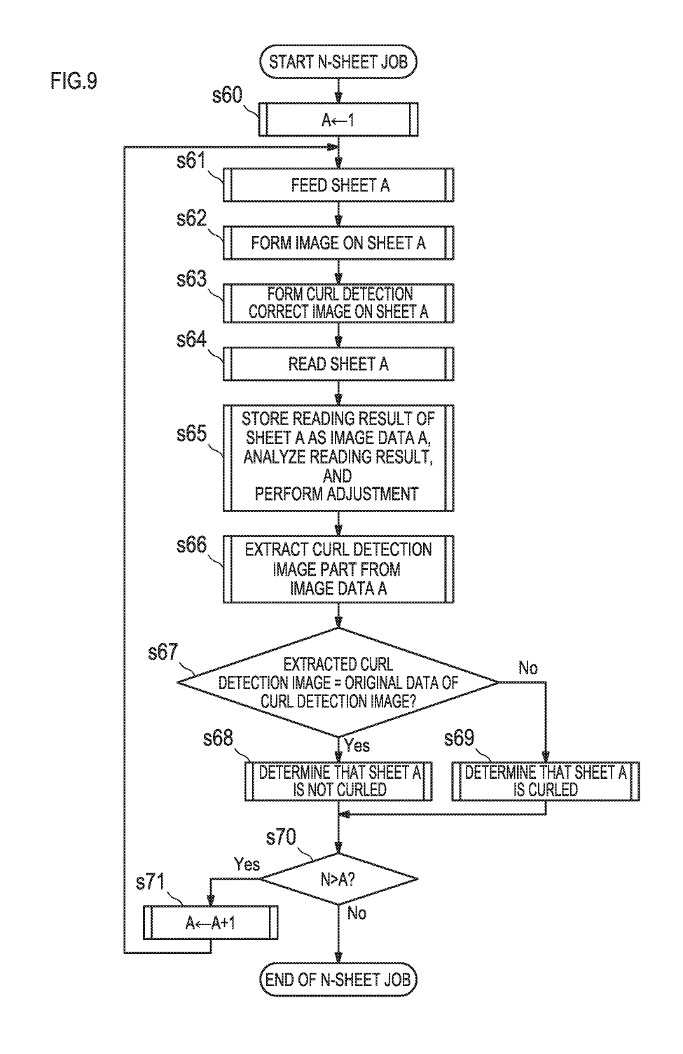

Next, referring to the flowchart of FIG. 9, the steps of determining a curling state based on curl detection images printed on a sheet will be described below.

First, 1 is substituted in a variable A (step s60). Subsequently, a sheet A is fed (step s61), and then an image is formed on the sheet A (step s62).

Curl detection correct images are formed on the sheet A (step s63), the sheet A is read by an output sheet reader (step s64), the reading result of the sheet A is stored as image data A, the reading result is analyzed, and then the image quality of an image forming device is adjusted (step s65).

Subsequently, a detection image part is extracted as a prescribed parameter from the image data A (step s66).

After that, it is determined whether a detection image serving as a prescribed parameter value is equal to a detection correct image serving as a prescribed parameter reference value (step s67).

If the prescribed parameter value and the prescribed parameter reference value are equal to each other (step s67, Yes), it is determined that the sheet A is not curled (step s68) and then it is determined whether N is larger than A (step s70). If N is larger than A (step s70, Yes), 1 is added to A (step s71) and then the process returns to step s61 to perform the step of feeding the sheet A.

If the prescribed parameter value is not equal to the prescribed parameter reference value (step s67, No), it is determined that the sheet A is curled (step s69) and then it is determined whether N is larger than A (step s70). If N is not larger than A (step s70, No), the job of N sheets is completed.

In the present embodiment, +curl/−curl (curling direction) can be determined according to a change of the curl detection image (e.g., whether a rectangle changed to a non-rectangular image or not, and the deformation direction of a rectangle).

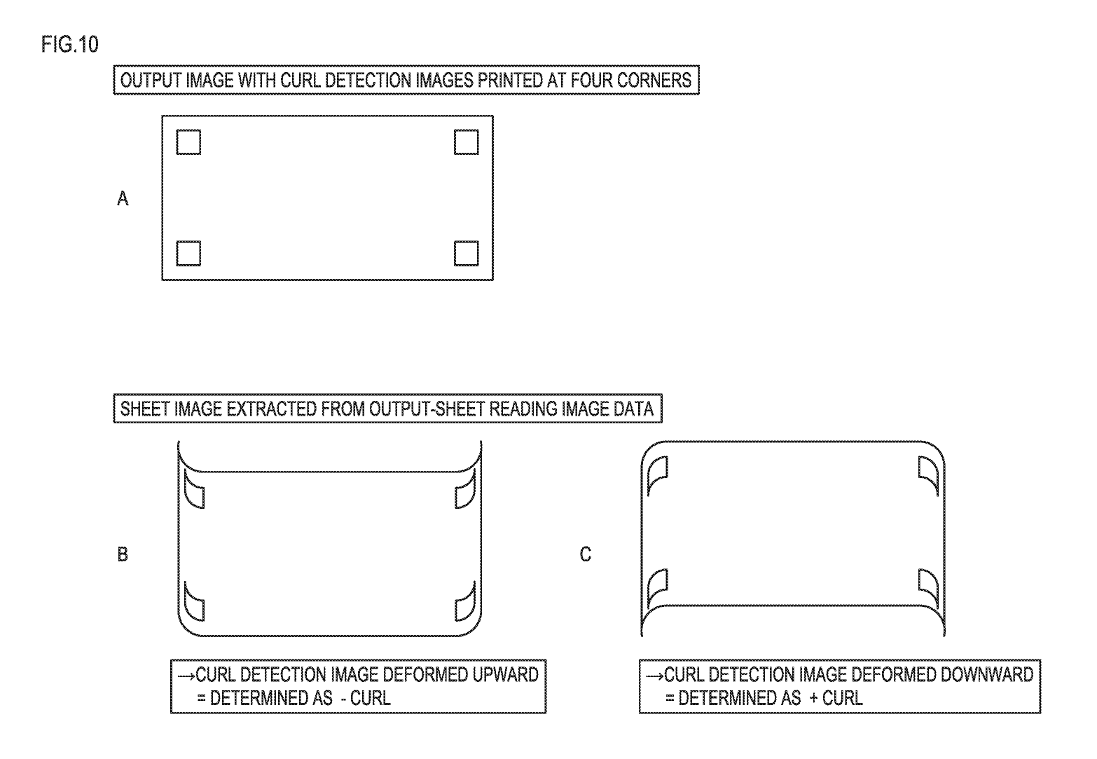

FIG. 10 shows a sheet having a detection correct image (A view) as a prescribed parameter reference value and a sheet image (B view) and a sheet image (C view) that are obtained by reading a curled sheet.

For example, the detection correct image as the reference value is formed into a rectangular shape. The detection image on the curled sheet is read as a distorted detection image. If the detection image is deformed upward (B view), it is determined that the sheet is curled in a direction (−). If the detection image is curled downward (C view), it is determined that the sheet is curled in a direction (+).

The detection image can be formed on, for example, a cutting margin or an inserted sheet.

In the present embodiment, the presence or absence of deformation, a direction of deformation, and an amount of deformation can be determined for each of the rectangular images at four corners. Thus, a decal can be adjusted only in the region of, for example, a curled corner.

In the present embodiment, the detection correct images are formed on the sheet. In the case of a sheet with printed register marks, the same determination can be made using the register marks as detection correct images. The curling direction and the curling amount of the sheet can be detected by analyzing the shapes of the register marks.

### Fifth Embodiment

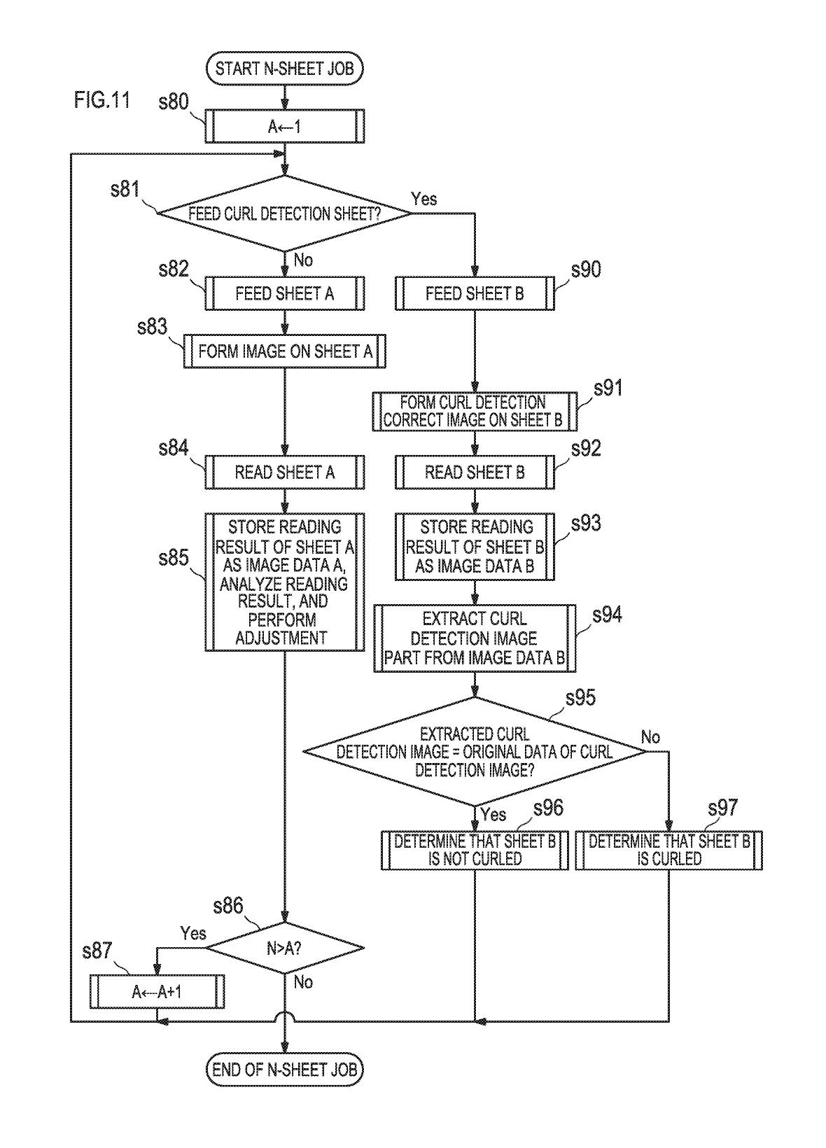

Next, referring to the flowchart of FIG. 11, the steps of detecting a curl by using a curl detection sheet during a job will be described below.

First, 1 is substituted in a variable A (step s80). Subsequently, it is determined whether to feed the curl detection sheet (step s81). Whether to detect a curl by using the curl detection sheet can be set beforehand according to a machine setting or a user instruction. Whether to feed the detection sheet can be set beforehand each time a certain number of sheets are fed or at every predetermined time. The determination can be also made at the setting of a job or the instruction of an output.

If the curl detection sheet is not fed (step s81, No), a sheet A is fed (step s82), an image is formed on the sheet A based on a job (step s83). Subsequently, the sheet A is read by an output sheet reader (step s84).

The reading result of the sheet A is stored as image data A, the reading result is analyzed, and then the image quality of an image forming device is adjusted (step s85).

Subsequently, it is determined whether N is larger than A (step s86). If N is larger than A (step s86, Yes), 1 is added to A (step s87) and then the process returns to step s81 to determine whether to feed the detection sheet. In the present embodiment, if the curl detection sheet is not fed, a curling state is not determined.

If the curl detection sheet is fed in step s81 (step s81, Yes), a sheet B is fed as a detection sheet (step s90), and curl detection correct images are formed on the sheet B (step s91). The sheet B can be the same paper type as the sheet A for printing a job, or the type of the sheet B can be different from that of the sheet A. The sheet B of the same type allows reproduction of a curling state of the sheet A with higher reliability.

Subsequently, the sheet B is read by an output sheet reader (step s92) and then the reading result of the sheet B is stored as image data B (step s93).

After that, a detection image is extracted as a predetermined parameter from the image data B (step s94) and then the detection image serving as a prescribed parameter value and a detection correct image serving as a prescribed parameter reference value are compared with each other (step s95).

If the prescribed parameter value and the prescribed parameter reference value are equal to each other (step s95, Yes), it is determined that the sheet B is not curled (step s96), and then the process returns to step s81 to determine whether to feed the curl detection sheet.

If the prescribed parameter value and the prescribed parameter reference value are not equal to each other (step s95, No), it is determined that the sheet B is curled (step s97) and then the process returns to step s81 to determine whether to feed the curl detection sheet.

### Sixth Embodiment

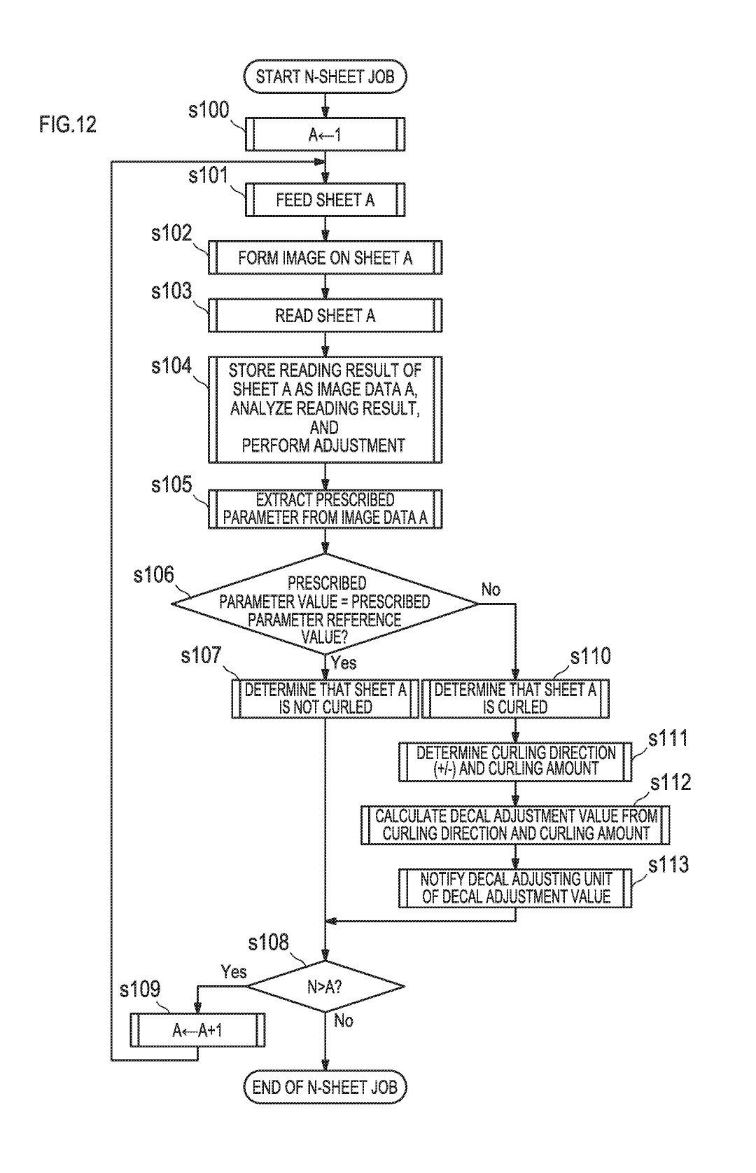

Next, referring to the flowchart of FIG. 12, steps will be discussed in which a curling state is determined based on a sheet reading result and curl correction is indicated in the presence of a curl. The following steps are performed under the control of a controller.

First, 1 is substituted in a variable A (step s100). Subsequently, a sheet A is fed (step s101), and then an image is formed on the sheet A based on a job (step s102).

After that, the sheet A is read by an output sheet reader (step s103), the reading result of the sheet A is stored as image data A, the reading result is analyzed, and then the image quality of an image forming device is adjusted (step s104).

Subsequently, a prescribed parameter is extracted from the image data A (step s105). It is then determined whether a prescribed parameter value and a prescribed parameter reference value are equal to each other (step s106).

If the prescribed parameter value and the prescribed parameter reference value are equal to each other (step s106, Yes), it is determined that the sheet A is not curled (step s107) and then it is determined whether N is larger than A (step s108). If N is larger than A (step s108, Yes), 1 is added to A (step s109) and then the process returns to step s101 to perform the step of feeding the sheet A.

If the prescribed parameter value is not equal to the prescribed parameter reference value (step s106, No), it is determined that the sheet A is curled (step s110), and then a curling direction (+/−) and a curling amount are determined (step s111). A decal adjustment amount (corresponding to a curl correction amount) is calculated from the curling direction and the curling amount (step s112), and then a decal adjusting unit (corresponding to a curl corrector in the present invention) is notified of the decal adjustment amount (step s113).

After that, it is determined whether N is larger than A (step s108). If N is not larger than A (step s108, No), the job of N sheets is completed.

### Seventh Embodiment

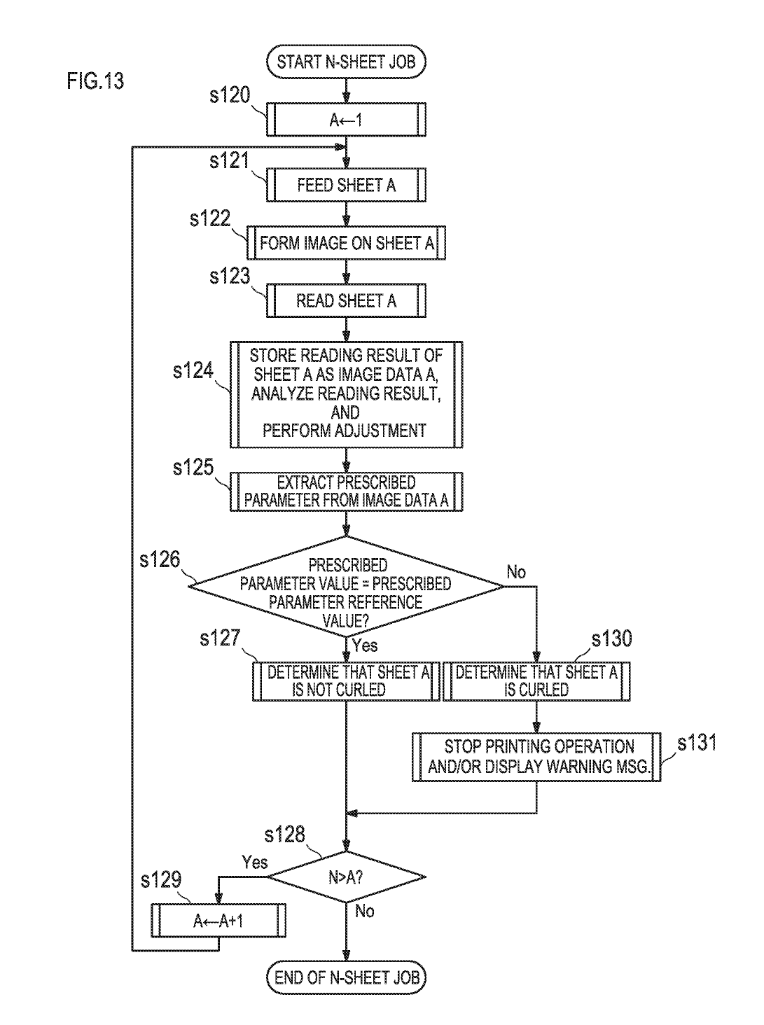

Next, referring to the flowchart of FIG. 13, steps will be discussed in which a curling state is determined based on a sheet reading result and a printing operation is stopped or a warning is displayed in the presence of a curl. The following steps are performed under the control of a controller, an information processing controller, or a detection controller. If image formation is separately controlled, image formation is controlled by an image formation controller.

First, 1 is substituted in a variable A (step s120). Subsequently, a sheet A is fed (step s121), and then an image is formed on the sheet A based on a job (step s122).

After that, the sheet A is read by an output sheet reader (step s123), the reading result of the sheet A is stored as image data A, the reading result is analyzed, and then the image quality of an image forming device is adjusted (step s124).

Subsequently, a prescribed parameter is extracted from the image data A (step s125). It is then determined whether a prescribed parameter value and a prescribed parameter reference value are equal to each other (step s126).

If the prescribed parameter value and the prescribed parameter reference value are equal to each other (step s126, Yes), it is determined that the sheet A is not curled (step s127) and then it is determined whether N is larger than A (step s128). If N is larger than A (step s128, Yes), 1 is added to A (step s129) and then the process returns to step s121 to perform the step of feeding the sheet A.

If the prescribed parameter value is not equal to the prescribed parameter reference value (step s126, No), it is determined that the sheet A is curled (step s130), and then a printing operation is stopped and/or a warning message is displayed (step s131).

After that, it is determined whether N is larger than A (step s128). If N is larger than A (step s128, No), the job of N sheets is completed.

The warning message can be displayed on an operation unit or can be a voice message. The warning message can be transmitted to an external device, a management server, a terminal device, and so on to be notified. Alternatively, the warning message can be printed on a cutting margin of a sheet or on an inserted sheet.

In the foregoing embodiments, a curling state is determined based on a particular prescribed parameter and a particular prescribed parameter reference. A curling state can be determined using multiple prescribed parameters and multiple prescribed parameter criteria.

In the foregoing embodiments, a workflow can be provided to detect a curl and adjust a decal in the absence of a decal detection mechanism in a system including in-line unit for reading an outputted sheet. Moreover, a decal adjustment amount can be decided for each of four corners or/and each side on a sheet, achieving accurate decal processing. Furthermore, in-line reading of an output sheet can suppress the cost and ensure productivity.

According to the present embodiment, an image reading result of a transfer medium is acquired to identify a curling state of the transfer medium. This allows a precise determination without the need for a detection unit having a mechanical mechanism.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
an image forming device that forms an image; and
a controller that acquires an image reading result of reading of an image of a transfer medium and determines a curling state of the transfer medium based on the image reading result.

2. The image forming apparatus according to claim 1, wherein in the controller, the image reading result of reading of the image of the transfer medium can be used to determine an abnormality of an image or correct image quality in the image forming device.

3. The image forming apparatus according to claim 2, wherein in the controller, the image reading result used to determine an abnormality of an image or correct image quality is acquired along with a determination of a curling state or at a different opportunity other than during the determination of the curling state.

4. The image forming apparatus according to claim 1, wherein the image of the transfer medium is read upstream of the image forming device and/or downstream of the image forming device that has been passed through the image forming device.

5. The image forming apparatus according to claim 1, further comprising an image reader.

6. The image forming apparatus according to claim 1, wherein
a image reader that reads an image of the transfer medium include nip portions that nip the transfer medium, and
presence and absence of a nipping operation performed by the nip portions and/or nipping points can be switched according to an image reading operation.

7. The image forming apparatus according to claim 6, wherein the switching is performed under control of the controller.

8. The image forming apparatus according to claim 6, wherein when an image is read to determine a curling state, a nipping operation is not performed by the nip portions.

9. The image forming apparatus according to claim 6, wherein when an image is read to determine an abnormality of the image or adjust image quality, a nipping operation is performed by the nip portions.

10. The image forming apparatus according to claim 1, further comprising a curl corrector that corrects a curl in response to a determination result of a curling state.

11. The image forming apparatus according to claim 1, wherein in the determination of a curling state, the controller compares a prescribed parameter extracted from the image reading result with a prescribed parameter reference, and determines a curling state according to a comparison result.

12. The image forming apparatus according to claim 11, wherein if the prescribed parameter and the prescribed parameter reference are not identical to each other, the controller determines that the transfer medium is curled.

13. The image forming apparatus according to claim 11, wherein the prescribed parameter is an output sheet size and a prescribed parameter reference value is a feeding sheet size.

14. The image forming apparatus according to claim 13, wherein the output sheet size is a size in a transport direction.

15. The image forming apparatus according to claim 13, wherein the output sheet size is a size in a crosswise direction.

16. The image forming apparatus according to claim 11, wherein the prescribed parameter is a curl detection image and a prescribed parameter reference value is a curl detection correct image.

17. The image forming apparatus according to claim 16, wherein the curl detection correct image is a rectangular patch and the prescribed parameter is a measured degree of deformation of the rectangular patch in image data of an output transfer medium.

18. The image forming apparatus according to claim 16, wherein the curl detection correct image is a register mark and the prescribed parameter is a measured degree of deformation of the register mark.

19. The image forming apparatus according to claim 16, wherein the curl detection image is printed on a cutting margin.

20. The image forming apparatus according to claim 16, wherein the curl detection image is printed on a transfer medium different from a transfer medium of a job during output of the job.
